(19) United States
(12) Patent Application Publication
(10) Pub. No.: US 2009/0252154 A1
(43) Pub. Date: Oct. 8, 2009

(54) SYSTEM FOR INTEGRATING AND TRANSMITTING NETWORK PHONE SIGNALS AND METHOD APPLIED THEREIN

(75) Inventor: Ivan Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: CHUNGHWA TELECOM CO., LTD., Taipei (TW)

(21) Appl. No.: 12/340,201

(22) Filed: Dec. 19, 2008

(30) Foreign Application Priority Data
Apr. 7, 2008 (TW) 097112468

(51) Int. Cl. H04L 12/66

(52) U.S. Cl. 370/352

(57) ABSTRACT

A system for integrating and transmitting network phone signals and a method applied therein. The system and method provide a medium server device applicable between network phone client ends and network phone message exchange system, the medium server device enabling the network phone client ends and the network phone message exchange system to process message exchanges between TCP port 80 and UDP port 5060 and/or UDP port 1024˜65535 transmission protocols. Accordingly, a network phone client end is capable of directly communicating with other local phone client ends and/or network phone client ends in the UDP port 80 transmission protocol.

### BACKGROUND OF THE INVENTION

1. Field of the Invention

This invention generally relates to a system for integrating and transmitting phone signals and a method applied therein, and more specifically, to a system for integrating and transmitting network phone signals and a method applied therein.

2. Description of Related Art

Along with worldwide development of the Internet, the Internet has been taking the places of fixed network local phones or cellular phones and used as voice and/or image transmission interface. Generally speaking, an Internet phone provides phone users with more powerful and additional functions and lower expenditure on phone bills.

Wherein an IP phone that uses voice over Internet protocol (VoIP) technologies, also known as a cable phone or network phone, is a modern telephone communication via Internet or other networks applying IP technology. In the past, the IP phone was mainly applied to intranet of large-scaled company, technical personnel could further provide data and voice/image service via the same network, not only simplifying management, but also increasing productivity. Owing to the ever-increasing popularity of the Internet and magnificent enhancement of telecommunication quantity, IP phones are in wide use in long distance telephone industry. Owing to keen competition among telecommunications corporations in major cities around the world and lenient attitudes of the international community toward telecommunication laws, IP phones have been applied to fixed network communication, furthermore, due to major features of the IP phone, such as low conversation session cost, low setup cost, easy expansibility, better voice/image quality day by day, etc., IP phones are viewed by modern international telecom industry as a powerful competitor against conventional telecom industry.

Since a conventional IP phone still needs practical communication equipment something like a fixed network local telephone set, users' application is thus restricted to hardware equipment, thereby lacking for flexibility. Besides, purchase price or setup cost is not necessarily lower than a conventional local telephone set. In order to overcome the disadvantage due to the demand for hardware equipment, a technique known as Web Call was developed. The technique of Web Call allows voice/image communication to be processed directly via a network browser according to an IP phone communication protocol.

Web Call is compatible to any standard IP phone protocol, difference from the IP phone is that the Web Call does not need independent application software for a management purpose, the Web Call is capable of communicating on the Web via a network browser, thereby being free from restriction of conventional IP phone hardware equipment; meanwhile, during the process of using the Web Call, a user is able to call other user anonymously, and normally there is no charge.

Although the Web Call has advantages, such as usage flexibility due to no need of extra hardware equipment and/or free or reduced cost at voice/image transmission, the voice/image transmission is executed via network browser by using transmission control protocol (TCP) port 80. However, for those Web Call client ends having firewall and applying this kind of transmission mode, voice/image transmission is commonly blocked by the firewall during process, thereby disabling those Web Call clients from communicating with other local phone and/or network phone client ends using User Datagram Protocol (UDP) port 5060 and/or UDP port 1024˜65535 transmission protocols.

In order to solve the problem that the TCP port 80 cannot pass through firewall, a correction mechanism for related parameter must be provided in Web Call application program. However, this approach is restricted by particular Web Call application program, thereby incapable of solving the problem that voice/image transmission of general Web Call is blocked by firewall during the transmission process.

### SUMMARY OF THE INVENTION

In view of the disadvantages of the prior art mentioned above, it is a primary objective of the present invention to provide a system for integrating and transmitting network phone signals and a method applied therein, enabling network phone client ends and network phone message exchange system to execute processes of exchanging messages between TCP port 80 and UDP port 5060 and/or UDP port 1024˜65535 transmission protocols, thereby allowing the network phone client ends to directly communicate with other local phone and/or network phone client ends.

The system for integrating and transmitting network signals according to the present invention includes: a receiving module for receiving first network phone signals complying in format with a first transmission protocol sent from a Web Call client end and second network phone signals complying in format with a second transmission protocol sent from a second client end sent from another local phone client end and/or network phone client end; an intermediate medium server connected to the receiving module for processing conversion of the first network phone signals from complying in format with the first transmission protocol to complying in format with the second transmission protocol, and conversion of the second network phone signals from complying in format with the second transmission protocol to complying in format with the first transmission protocol; and a transmitting module connected to the intermediate medium server for transmitting the first network phone signals complying in format with the second transmission protocol by the intermediate medium server to the second client end and/or the second network phone signals complying in format with the first transmission protocol by the intermediate medium server to the first client end.

In another embodiment of the present invention, the system further includes a connection module for enabling the Web Call client end, the local phone client end, and/or the network phone client end to build connection with the intermediate medium server. Preferably, the connection module is built into the Web Call client end, the local phone client end, and/or the network phone client end.

In a further embodiment of the present invention, the connection module comprises an information processing unit for compressing the first and second network phone signals, dividing the compressed signals into a plurality of information blocks, and assembling the divided information blocks to information packet complying in format with the first or second transmission protocol.

The method for integrating and transmitting network phone signals according to the present invention includes: receiving network phone signals including network phone signals sent from a Web Call client end and transmitted according to a TCP port 80, network phone signals sent from local phone client end and/or network phone client ends and transmitted according to UDP port 5060 and/or UDP port 1024˜65535 transmission protocols; determining transmission protocol of target client end, to which the received network phone signals are to be sent; processing conversion between TCP port 80 and UDP port 5060 and/or UDP port 1024˜65535 transmission protocols based on outcome of the judging process; and transmitting the converted network phone signals to the target client end.

In another embodiment of the present invention, the method further includes building connections for the Web Call client end, the local phone client end and/or the network phone client end with an intermediate medium server. Preferably, process of connection is executed on at least one among the Web Call client end, the local phone client end and/or the network phone client end.

In a further embodiment of the present invention, the method further includes: compressing the first and second network phone signals; dividing the compressed signals into a plurality of information blocks; and assembling the divided information blocks to an information packet complying in format with the first or second transmission protocol.

Compared with the prior art, wherein Web Call that applies TCP port 80 transmission protocol has to use particular application program for passing through firewall, the intermediate medium server mechanism provided by the system and method of the present invention for integrating and transmitting network phone signals enables the network phone client end and network phone message exchange system to execute processes of exchanging messages between TCP port 80 and UDP port 5060 and/or UDP port 1024'65535 transmission protocols, thereby achieving objective of enabling the network phone client end to directly communicate with other local phone and/or network phone client ends according to the TCP port 80 transmission protocol.

### BRIEF DESCRIPTION OF DRAWINGS

The present invention can be more fully understood by reading the following detailed description of the preferred embodiments, with reference made to the accompanying drawings, wherein:

FIG. 1 is an application architecture diagram of a system for integrating and transmitting network phone signals according to the present invention;

FIG. 2 is a flowchart illustrating a method for integrating and transmitting network phone signals according to the present invention;

FIG. 3 is a diagram illustrating communication status between a first client end and a second client end; and

FIGS. 4a and 4b are diagrams illustrating process flows of control signals and messages including texts, voices and/or images between the first client end and an intermediate medium server while executing the system and method of the present invention for integrating and transmitting network phone signals.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

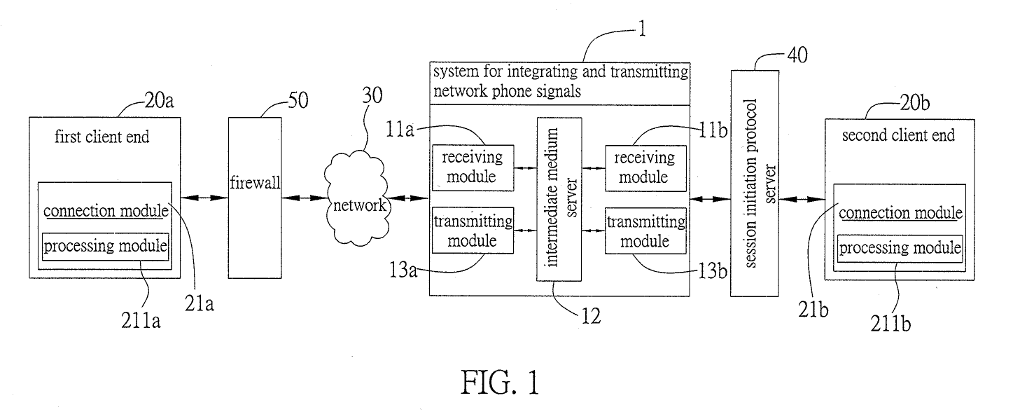

Please refer to FIG. 1, which is an application architecture diagram illustrating a system 1 for integrating and transmitting network phone signals according to the present invention. The system 1 for integrating and transmitting network phone signals comprises receiving modules 11a and 11b, an intermediate medium server 12, and transmitting modules 13a and 13b, and communicates with a first client end 20a via a network 30 and a second client end 20b via a session initiation protocol (SIP) server 40.

The first client end 20a transmits messages in a first transmission protocol, the second client end 20b transmits messages in a second transmission protocol, and both of the first transmission protocol and the second transmission protocol are TCP port 80, UDP port 5060 or UDP port 1024˜65535.

For example, the first client end 20a transmits control signals and/or messages including texts, voices and/or images in TCP port 80 transmission protocol, and the second client end transmits control signals in UDP port 5060 port transmission protocol, while transmits message including texts, voices and/or images in UDP port 1024˜65535 transmission protocol. In other embodiments of the present invention, the system 1 can further communication with other client ends, and these client ends can transmit control signals and/or messages including texts, voices and/or images in any one of the above transmission protocols.

Specifically, the first client end 20a is a Web Call client end employing RTP protocol, while the second client end 20b is a VoIP client end employing RTP protocol. In other embodiments of the present invention, the first client end 20a or the second client end 20b can be a fixed network local phone client end employing public switched telephone network (PSTN).

In the present embodiment, the first client end 20a has a connection module 21a, and the second client end 20b has a connection module 21b. The connection modules 21a and 21b are for connecting with the system 1 by means of peer to peer connection or other connection mode via the network 30, and further for processing message transmission therebetween.

In addition, the connection module 21a comprises an information processing unit 211a, and the connection module 21b comprises an information processing unit 211b. The information processing units 211a and 211b are for compressing the first and second network phone signals including control signals, and/or messages including texts, voices and/or images, etc., dividing the compressed signals into a plurality of information blocks, and assembling the divided information blocks to an information packet complying in format with the first or second transmission protocol. In the present embodiment, the connection module 21a is for compressing the information of the first client end 20a including control signals and/or messages including texts, voices and/or images, etc into TCP packets, while the connection module 21b is for compressing the network phone signals of the second client end 20b including control signals and/or messages including texts, voices and/or images, etc. to UDP packets.

The network 30 can be a local area network or a wide area network. The network 30 employs a wired network connection such as asynchronous digital subscriber line (ADSL) and Fiber To The Building (FTTB), or a wireless network connection. The architecture of the network 30 can be the Internet, intranet, extranet, wired/wireless local area network (LAN), or virtual private network (VPN).

The session initiation protocol (SIP) server 40 is connected to the intermediate medium server 12 for enabling the second client end 20b to transmit control signals and/or messages including texts, voices and/or images according to UDP port 5060 and UDP port 1024˜65535 transmission protocols.

Accordingly, the receiving module 11a is for receiving network phone signals sent from the first client end 20a and transmitted according to the TCP port 80 transmission protocol, while the receiving module 11b is for receiving network phone signals sent from the second client end 20b and transmitted by the session initiation protocol server 40 according to the UDP port 5060 and UDP port 1024˜65535 transmission protocols.

More specifically, the receiving module 11a is for receiving control signals and/or messages including texts, voices and/or images transmitted sent from the first client end 20a according to the TCP port transmission protocol, and the receiving module 11b is for receiving control signals sent from the second client end 20b and transmitted by the session initiation protocol server 40 according to the UDP port 5060 transmission protocol, and for receiving messages including texts, voices and/or images sent from the second client end transmitted by the session initiation protocol server 40 according to the UDP port 1024˜65535 transmission protocol.

More specifically, the receiving module 11a is for receiving control signals and/or messages including texts, voices and/or images sent from the first client end 20a and separately compressed by the information processing unit 211a and then transmitted according to the TCP port 80 transmission protocol, and the receiving module 11b is for receiving control signals sent from the second client end 20b and compressed by the information processing unit 211b and then transmitted by the session initiation protocol server 40 according to the UDP port 5060 transmission protocol, and for receiving network phone signals including texts, voices and/or images sent from the second client end 20b and compressed by the information processing unit 211b and then transmitted by the session initiation protocol server 40 according to the UDP port 1024˜65535 transmission protocol.

The intermediate medium server 12 is connected to the receiving module for processing conversion between the TCP port 80 and the UDP port 5060 and UDP port 1024˜65535 transmission protocols. After receiving a port 80 TCP packet, the intermediate medium server 12 accesses a plurality of information blocks of control signal therefrom, and then puts the information blocks of control signals into a UDP packet complying in format with an SIP protocol, and then the transmitting module 13a transmits the UDP packet to the session initiation protocol server 40 according to port 5060. Meanwhile, the intermediate medium server 12 accesses a plurality of information blocks of message including texts, voices and/or images and then puts them into a UDP packet complying in format with the SIP protocol, and then the transmitting module 13a transmits said UDP packet to the session initiation protocol server 40 according to port 1024˜65535. Subsequently, the session initiation protocol sever 40 transmits the information blocks of control signals and/or information blocks of messages including texts, voices and/or images to the second client end 20b.

Correspondingly, after receiving the UDP packet complying in format with the SIP protocol and transmitted from the session initiation protocol server 40 (the UPD packet including the information blocks of UDP port 5060 control signal and/or information blocks of UDP port 1024˜65535 messages including texts, voices and/or images), the intermediate medium server 12 accesses the information blocks of control signal and/or the information blocks of messages including texts, voices and/or images therefrom and then puts them into the port 80 TCP packet complying in format with TCP protocol. Subsequently, the transmitting module 13b transmits an information packet to the first client end 20a according to the TCP port 80.

Since the first client end 20a transmits control signals and/or messages including texts, voices and/or images according to the TCP port 80 transmission protocol, thereby allowing the control signals and/or messages to pass through a firewall 50 without installing other application programs for correcting related parameters.

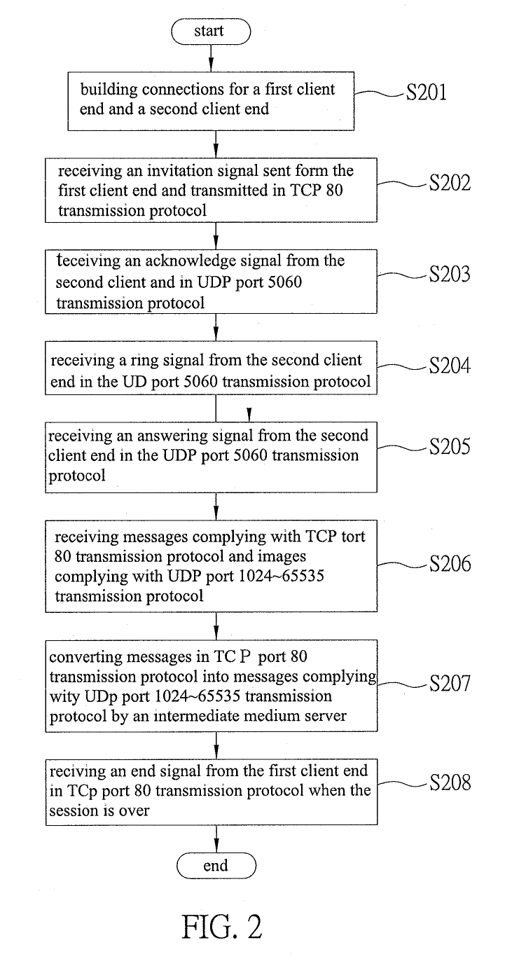

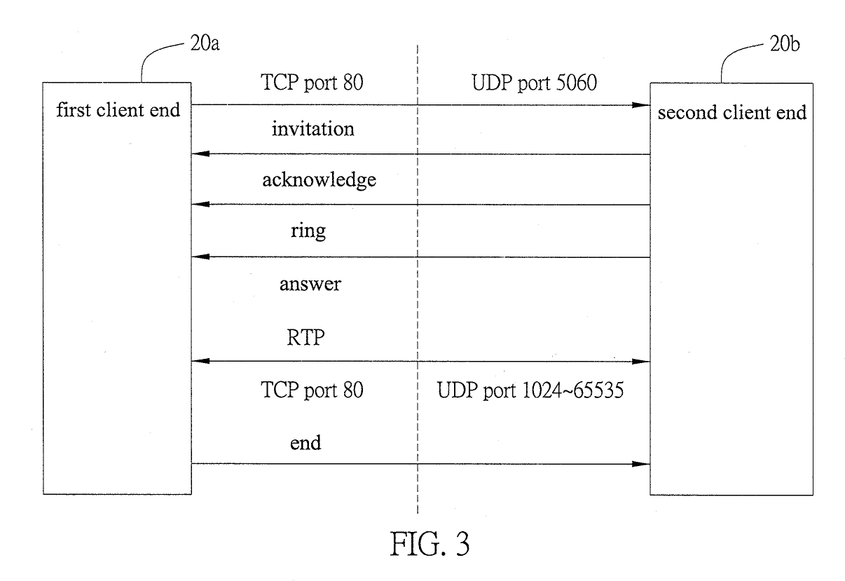

Please refer to FIGS. 2 and 3. FIG. 2 is a flow chart illustrating a method of the present invention for integrating and transmitting network phone signals. FIG. 3 is a diagram illustrating communication status of the first client end 20a and the second client end 20b. As shown in FIG. 2, in step S201, building connections for the first client end 20a and the second client end 20b with the intermediate medium server 12. Next, proceeding to step S202.

In the step S202, the second client end 20b receives an invitation signal sent from the first client end 20a and transmitted according to a TCP port 80 transmission protocol. The invitation signal has been converted from the TCP port 80 transmission protocol to a UDP port 5060 transmission protocol by the intermediate medium server 12, and then transmitted to the second client end 20b by the session initiation protocol server 40. Next, proceeding to step S203.

In the step S203, the first client end 20a receives an acknowledgement signal from the second client end 20b in UDP port 5060 transmission protocol. The acknowledgement signal is first transmitted to the intermediate medium server 12 by the session initiation protocol server 40, and then further converted to a TCP port 80 transmission protocol by the intermediate medium server 12, subsequently transmitted to the first client end 20a. Next, proceeding to step S204.

In the step S204, the first client end 20a receives a ring signal from the second client end 20b according to the UDP port 5060 transmission protocol. The ring signal is first transmitted to the intermediate medium server 12 by the session initiation protocol server 40, and then converted to the TCP port 80 transmission protocol by the intermediate medium server 12, subsequently transmitted to the first client end 20a. Next, proceeding to step S205.

In the step S205, the first client end 20a receives an answering signal from the second client end 20b according to the UDP port 5060 transmission protocol. The answering signal is first transmitted to the intermediate medium server 12 by the session initiation protocol server 40, and then converted to the TCP port 80 transmission protocol by the intermediate medium server 12, subsequently transmitted to the first client end 20a. Thus, the signal communication between the first client end 20a and the second client end 20b is completed. Next, proceeding to step S206.

In the step S206, the intermediate medium server 12 receives messages including texts, voices and/or images complying in format with TCP port 80 transmission protocol and sent from the first client end 20a and transmitted according to a RTP protocol, and receives messages including texts, voices and/or images complying in format with the UDP port 1024˜65535 transmission protocol and sent from the second client end 20b and transmitted by the session initiation protocol server 40 according to the RTP protocol. Next, proceeding to step S207.

In the step S207, converting messages including texts, voices and/or images in TCP port 80 transmission protocol into messages including texts, voices and/or images complying in format with the UDP port 1024˜65535 transmission protocol by the intermediate medium server 12, and vice versa. Next, proceeding to step S208.

In step S208, when the session is over, the second client end 20b receives an end signal from the first client end 20a according to the TCP port 80 transmission protocol. The end signal is converted from the TCP port 80 transmission protocol into the UDP port 5060 transmission protocol by the intermediate medium server 12, and then transmitted to the second client end 20b by the session initiation protocol server 40, subsequently the second client end 20b hangs up and the session ends.

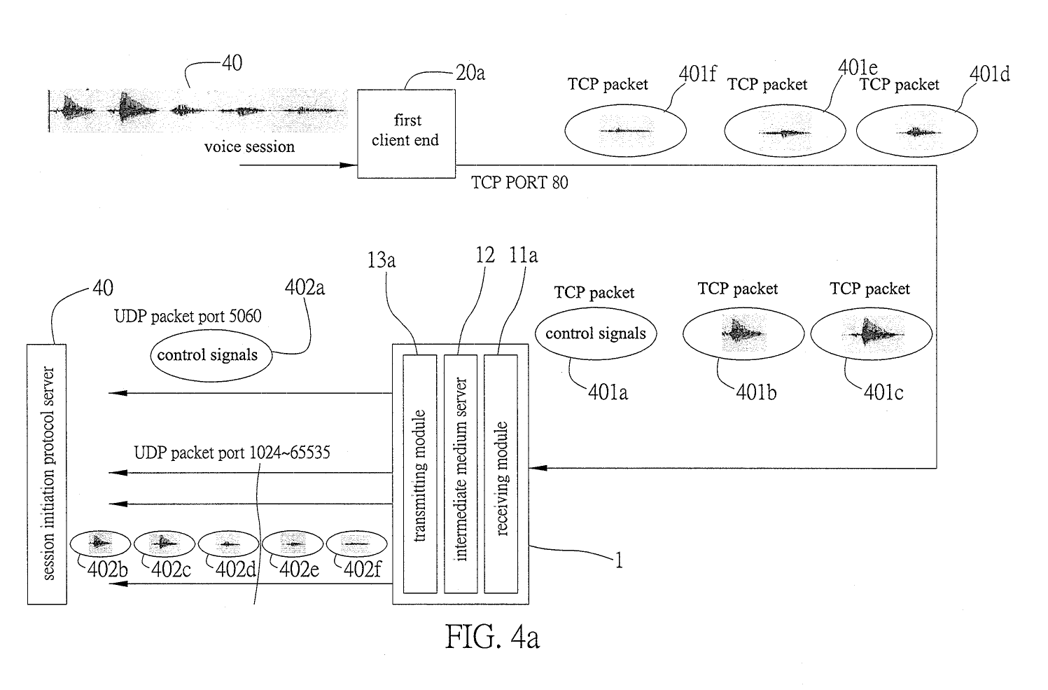

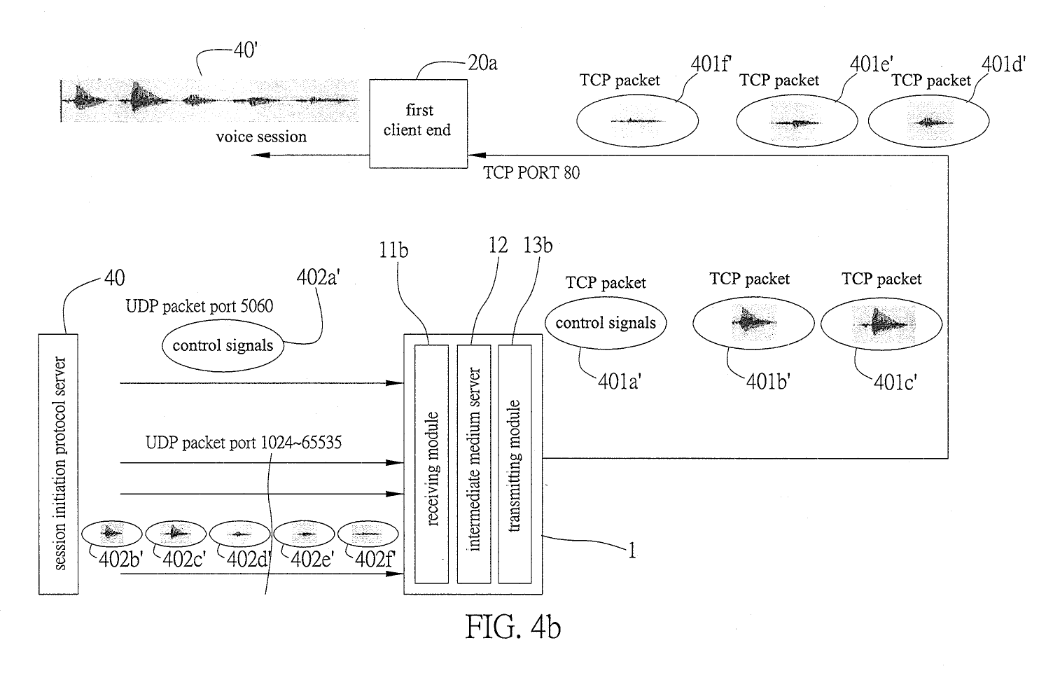

Please refer to FIGS. 4a and 4b, which are diagrams illustrating process flows of control signals and messages including texts, voices and/or images between the first client end 20a and the intermediate medium server 12 while executing the system and method of the present invention for integrating and transmitting network phone signals.

As shown in FIG. 4a, a user inputs analog voice section 40 to the first client end 20a, and the information processing unit 211a of the first client end 20a compresses signals including control signals and messages including texts, voices and/or images, etc., divides the compressed signals including control signals and/or messages including texts, voices and/or images, etc. to information blocks, and assembles the divided information blocks to an information packet complying in format with the first or second transmission protocol. In the present embodiment, information of the first client end 20a, including control signals and/or messages including texts, voices and/or images, etc., is compressed to a TCP packet of control signals 401a, and TCP packets of messages including texts, voices and/or images, 401b, 401c, 401d, 401e, and 401f.

After receiving the TCP packet of control signals 401a and the TCP packets of messages including texts, voices and/or images 401b, 401c, 401d, 401e, and 401f by the receiving module 11a, the intermediate medium server 12 accesses the TCP packet of control signals 401a and puts it in a UDP packet 402a complying in format with a SIP protocol. Subsequently, the transmitting module 13a transmits the UDP packet of control signals 402a to the session initiation protocol server 40 according to the port 5060. On the other hand, the intermediate medium server 12 accesses the TCP packets of messages including texts, voices and/or images 401b, 401c, 401d, 401e, and 401f and then puts them in UDP packets of messages 402b, 402c, 402c, 402d, 402e, and 402f complying in format with SIP protocol. Subsequently, the transmitting module 13a transmits the UDP packets 402b, 402c, 402c, 402d, 402e, and 402f to the session initiation protocol server 40 according to the port 1024˜65535.

Subsequently, the session initiation protocol server 40 transmits the UPD packet of control signals 402a and UDP packets of messages including texts, voices and/or images 402b, 402c, 402c, 402d, 402e, and 402f to the second client end 20b.

Please refer to FIG. 4b. The intermediate medium server 12 receives, via the receiving module 11b, a UDP packet of control signals 402a′ and UDP packets of messages including texts, voices and/or images 402b′, 402c′, 402d′, 402e′, and 402f′ from the second client end 20b transmitted by the session initiation server 40.

The intermediate medium server 12 accesses the UDP packet 402a′ and puts it in a TCP packet 401a′ complying in format with the TCP port 80 protocol. Subsequently, the transmitting module 13b transmits the TCP packet 401a′ to the first client end 20a according to the TCP port 80. On the other hand, the intermediate medium server 12 accesses the UDP packets of messages including texts, voices and/or images 402b′, 402c′, 402d′, 402e′, and 402f′ and puts them in TCP packets 401b′, 401c′, 401d′, 401e′, and 401f′. Subsequently, the transmitting module 13b transmits the TCP packets 401b′, 401c′, 401d′, 401e′, and 401f to the first client end according to the TCP port 80.

Compared with the prior art, wherein Web Call applying the TCP port 80 transmission protocol has to use particular application program to pass through firewall, the system and method for integrating and transmitting network phone signals according to the present invention provides the intermediate medium server mechanism to enable the network phone clients and network phone message exchange system to process message exchanges between the TCP port 80 and UDP port 5060 and/or UDP port 1024˜65535 transmission protocols, thereby achieving objective of enabling the network phone clients to communicate directly with other local phone and/or network phone clients.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A system for integrating and transmitting network phone signals, comprising:
a receiving module for receiving first network phone signals complying in format with a first transmission protocol sent from a first client end and second network phone signals complying in format with a second transmission protocol sent from a second client end;
an intermediate medium server connected to the receiving module for processing conversion of the first network phone signals from complying in format with the first transmission protocol to complying in format with the second transmission protocol, and conversion of the second network phone signals from complying in format with the second transmission protocol to complying in format with the first transmission protocol; and
a transmitting module connected to the intermediate medium server for transmitting the first network phone signals complying in format with the second transmission protocol by the intermediate medium server to the second client end and/or the second network phone signals complying in format with the first transmission protocol by the intermediate medium server to the first client end.

2. The system of claim 1, further comprising connection modules for connecting the first client end and/or the second client end with the intermediate medium server.

3. The system of claim 2, wherein the connection modules connect the first client end and/or the second client end with the intermediate medium server in a peer to peer connection mode.

4. The system of claim 2, wherein the connection modules are built into the first client end and/or the second client end.

5. The system of claim 2, wherein each of the connection modules comprises an information processing unit for compressing the first and second network phone signals, dividing the compressed signals into a plurality of information blocks, and assembling the divided information blocks to an information packet complying in format with the first or second transmission protocol.

6. The system of claim 1, wherein the first transmission protocol and the second transmission protocol are TCP port 80, UDP port 5060, and/or UDP port 1024˜65535.

7. The system of claim 6, wherein control signals and messages including texts, voices and/or images of the first client end are transmitted according to a TCP port 80 transmission protocol, control signals of the second client end are transmitted according to the UDP port 5060 transmission protocol, and messages including texts, voices and/or images of the second client end are transmitted according to the UDP port 1024˜65535 transmission protocol.

8. The system of claim 7, further comprising a session initiation protocol server connected with the intermediate medium server for enabling the second client end to transmit control signals and messages including texts, voice and/or images according to the UDP port 5060 and UDP port 1024˜65535.

9. The system of claim 8, wherein the receiving module receives the first network phone signals complying in format with the first transmission protocol sent from the first client end and transmitted according to the TCP port 80 transmission protocol, receives the second network phone signals complying in format with the second transmission protocol sent from the second client end and transmitted by the session initiation protocol server according to the UDP port 5060 and UDP port 1024˜65535 transmission protocols.

10. The system of claim 9, wherein the receiving module receives control signals and messages including texts, voices and/or images sent from the first client end and transmitted according to the TCP port 80 transmission protocol, receives control signals sent from the second client end and transmitted by the session initiation protocol server according to the UDP port 5060 transmission protocol and messages including texts, voices and/or images sent from the second client end and transmitted by the session initiation protocol server according to the UDP port 1024˜65535 transmission protocol.

11. The system of claim 9, further comprising an information processing unit, wherein the receiving module receives control signals and messages including texts, voices and/or images sent from the first client end and separately compressed by an information processing unit and transmitted according to the TCP port 80 transmission protocol, and receives control signals sent from the second client end and transmitted by the session initiation protocol server according to the UDP port 5060 and messages including texts, voices and/or images sent from the second client end and transmitted by the session initiation protocol server according to the UDP port 1024˜65535.

12. The system of claim 1, wherein the first client end and/or the second client end are connected with the intermediate medium server via a network.

13. The system of claim 12, wherein the network is a local area network or a wide area network.

14. The system of claim 12, wherein the network adopts a wired ADSL or FTTB network connection and/or wireless network connection mode.

15. The system of claim 12, wherein the network has a network architecture built according to the Internet, intranet, extranet, wired/wireless local network, and/or virtual private network

16. A method for integrating and transmitting network phone signals, comprising the steps of:
(1) receiving first network phone signals sent from a first client end and transmitted according to a first transmission protocol and/or second network phone signals sent from a second client end and transmitted according to a second transmission protocol;
(2) determining the transmission protocol of the first client end and/or the second client end, to which the first and/or second network phone signals received are to be transmitted;
(3) processing conversion between the first transmission protocol and the second transmission protocol based on outcome of previous determining process; and
(4) transmitting the first and/or second network phone signals to predetermined target first client end and/or second client end.

17. The method of claim 16, further comprising step (a) building connections for the first client end and/or the second client end with an intermediate medium server, wherein step (a) is executed earlier than step (1).

18. The method of claim 17, wherein step (a) is executed in the first client end and/or the second client end.

19. The method of claim 17, wherein step (a) further comprises:
(a-1) compressing the first and second network phone signals;
(a-2) dividing the compressed signals into a plurality of information blocks; and
(a-3) assembling the divided information blocks to an information packet complying in format with the first or second transmission protocol.

20. The method of claim 16, wherein the first transmission protocol and the second transmission protocol are a TCP port 80, UDP port 5060, or UDP port 1024˜65535.

21. The method of claim 20, wherein the first client end transmits control signals and messages including texts, voices and/or images according to the TCP port 80 transmission protocol, and the second client end transmits control signals according to the UDP port 5060 transmission protocol and messages including texts, voices and/or images according to the UDP port 1024˜65535 transmission protocol.

22. The method of claim 21, further comprising:
(b-1) providing a session initiation protocol server; and
(b-2) enabling the second client end to transmit control signals and/or messages including texts, voices and/or images according to the UDP port 5060 and UDP port 1024˜65535 transmission protocols.

23. The method of claim 22, wherein step (1) is for receiving the first network phone signals sent from the first client end and transmitted according to the TCP port 80 transmission protocol, and for receiving the second network phone signals sent from the second client end and transmitted by the session initiation protocol server according to the UDP port 5060 and UDP port 1024˜65535 transmission protocols.

24. The method of claim 23, wherein step (1) is for receiving control signals and/or messages including texts, voices and/or images sent from the first client end and transmitted according to the TCP port 80 transmission protocol, and for receiving control signals sent from the second client end transmitted by the session initiation protocol sever according to the UDP port 5060 transmission protocol and messages including texts, voices and/or images sent from the second client end transmitted by the session initiation protocol server according to the UDP port 1024˜65535 transmission protocol.

25. The method of claim 24, wherein step (1) is for receiving control signals and messages including texts, voices and/or images sent from the first client end and separately compressed by an information processing unit and transmitted according to the TCP port 80 transmission protocol, and for receiving control signals sent from the second client end and transmitted by the session initiation protocol server according to the UDP port 5060 transmission protocol and messages including texts, voices and/or images sent from the second client end and transmitted by the session initiation protocol server according to the UDP port 1024˜65535 transmission protocol.

26. The method of claim 16, wherein the first client end and/or the second client end are connected with the intermediate medium server via a network.

27. The method of claim 26, wherein the network is a local area network or a wide area network.

28. The method of claim 26, wherein the network adopts a wired ADSL or FTTB network connection and/or wireless network connection mode.

29. The method of claim 26, wherein the network has a network architecture built according to the Internet, intranet, extranet, wired/wireless local area network, and/or virtual private network.

30. The method of claim 16, wherein the messages include invitation, acknowledgement, ring, answering, and/or end signals
